(19) United States
(12) Patent Application Publication
(10) Pub. No.: US 2009/0226248 A1
(43) Pub. Date: Sep. 10, 2009

(54) Quick-Release Coupler

(76) Inventor: Tzu-Chien Wang, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/044,037

(22) Filed: Mar. 7, 2008

(51) Int. Cl. F16C 3/00

(52) U.S. Cl. 403/322.2; 464/182

(57) ABSTRACT

A quick-release coupler includes a rod having a first end for coupling with a pneumatic tool and a second end having a recess. A sleeve is slidably mounted around the rod and includes an end coupled with a bit. A ball is received in a radial bore in the sleeve and received in the recess of the rod to engage the sleeve with the rod. A spring is mounted in the sleeve for biasing the sleeve towards the second end of the rod. The ball projects out of the sleeve to engage the bit with the quick-release coupler when the ball is received in a first, shallower contact section. Removal of the bit from the quick-release coupler is allowed when the ball is received in a second, deeper contact section.

### BACKGROUND OF THE INVENTION

The present invention relates to a quick-release coupler and, more particularly, to a quick-release coupler for securely coupling a bit to a pneumatic tool.

FIG. 1 shows a conventional quick-release coupler 2 and a bit 1 coupled to the quick-release coupler 2. Bit 1 includes a driving end 12 for driving a screw or the like and a socket portion 11 having a coupling hole 111. A recessed portion 112 is formed in each of four side walls defining coupling hole 1. Quick-release coupler 2 includes a first end 21 for coupling with a hand-held tool such as a pneumatic tool (not shown) and a second end 22 having a receptacle 221 in which a spring 23 and a ball 24 are received. Ball 24 is biased by spring 23 such that an outermost portion 241 of ball 24 projects out of receptacle 221 and engages in one of recessed portions 112 of bit 1 when coupling hole 111 of bit 1 couples to second end 22 of quick-release coupler 4. Thus, bit 3 is locked on quick-release coupler 4 and can be driven when first end 21 of quick-release coupler 2 secured to the pneumatic tool rotates.

To remove bit 1 from quick-release coupler 2, a user generally grasps bit 1 and a handle of the pneumatic tool to pull them away from each other to make ball 24 retract into receptacle 221 to allow removal of bit 1 from quick-release coupler 2. However, it is sometimes difficult to remove bit 1 from quick-release coupler 2, particularly when ball 24 is jammed or the hands of the user are greasy. Moreover, bit 1 may be disengaged from quick-release coupler 2 during operation of the pneumatic tool when the resilience of spring 23 decreases.

### SUMMARY OF THE INVENTION

An objective of the present invention is to provide a quick-release coupler to allow secure attachment and easy removal of a bit to and from a hand-held tool such as a pneumatic tool.

A quick-release coupler according to the preferred teaching of the present invention includes a rod, a sleeve slidably mounted around the rod, a ball, and a spring. The rod includes a first end for coupling with a pneumatic tool and a second end having a recess. The recess includes a first, shallower contact section and a second, deeper contact section. The sleeve includes a first end, a second end adapted to couple with a bit and an axial bore extending from the first end through the second end for receiving the rod. The ball is movably received in the radial bore of sleeve along a vertical axis of the rod and moveably received in the recess of the rod along a longitudinal axis of the rod to engage the sleeve with the rod. The spring is mounted in the axial bore of the sleeve for biasing the sleeve towards the second end of the rod. The sleeve is moveable relative to the rod along the longitudinal axis of the rod between an extended, first position biased by the spring and a retracted, second position compressing the spring. The ball is engaged in the first contact section of the recess and an outermost portion of the ball projects out of the radial bore of the sleeve when the sleeve is in the extended, first position. The ball is engaged in the second contact section of the recess and does not project out of the radial bore of the sleeve when the sleeve is in the retracted, second position.

The present invention will become clearer in light of the following detailed description of an illustrative embodiment of this invention described in connection with the drawings.

### BRIEF DESCRIPTION OF THE DRAWINGS

The illustrative embodiment may best be described by reference to the accompanying drawings where:

FIG. 1 is a partly cross-sectioned side view of a conventional quick-release coupler with a bit shown attached thereto.

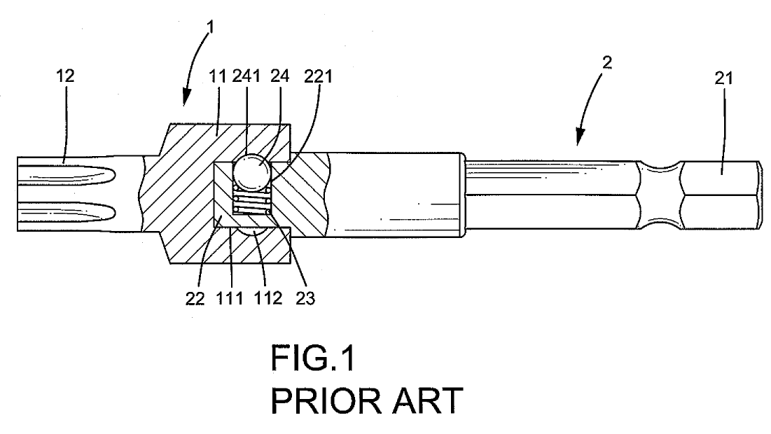

FIG. 2 shows a cross sectional view of a quick-release coupler according to the present invention with a bit attached thereto.

FIG. 3 shows an exploded perspective view of the quick-release coupler and the bit of FIG. 2.

FIG. 4 shows a cross sectional view of the quick-release coupler and the bit of FIG. 2 before engagement.

FIG. 5 shows a diagrammatic side view of the quick-release coupler and the bit of FIG. 2 and a pneumatic tool to which the quick-release coupler is coupled.

FIG. 6 is a cross sectional view taken along plane 6-6 in FIG. 2.

FIG. 7 is a view similar to FIG. 4, wherein the bit is being coupled with the quick-release coupler.

FIG. 8 is a view similar to FIG. 7, wherein the bit is moved to push a sleeve of the quick-release coupler in a retracted position, and a ball is received in the bit.

FIG. 9 is a view similar to FIG. 8, wherein the bit is moved to be in contact with a radial flange of the sleeve of the quick-release couple.

### DETAILED DESCRIPTION OF THE INVENTION

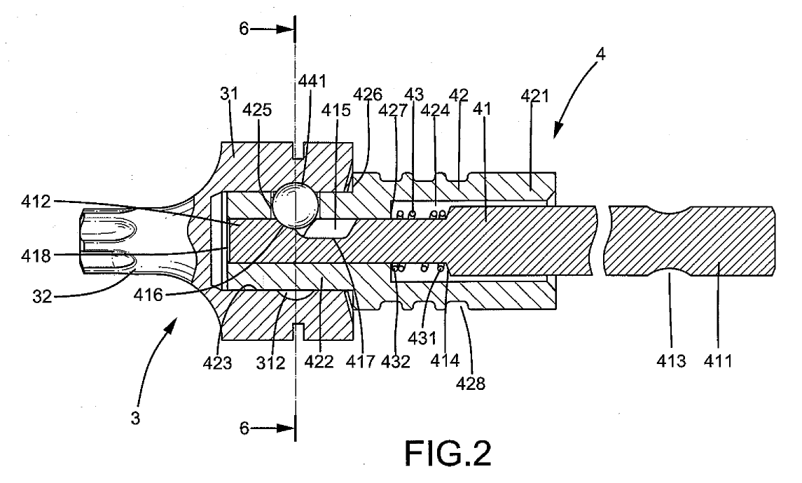

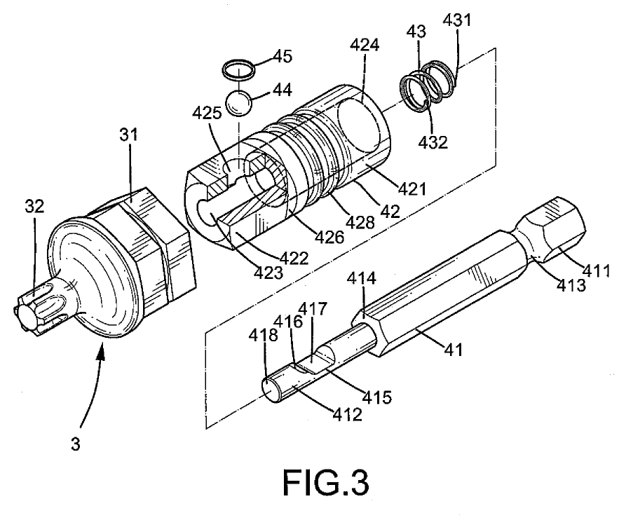

A quick-release coupler according to the preferred teachings of the present invention is shown in FIGS. 2 through 9 of the drawings and is designated 4. Quick-release coupler 4 includes a rod 41, a sleeve 42, a ball 44, and a spring 43.

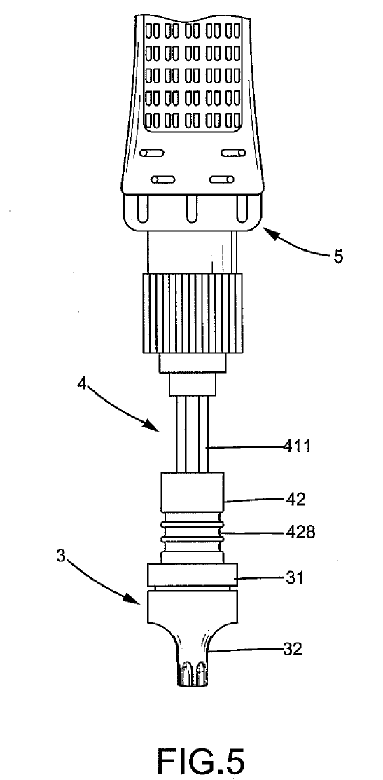

Rod 41 includes a first end 411 having an annular groove 413 by which rod 41 can be secured to a coupling end 51 of a pneumatic tool 5 (FIG. 5). Rod 41 further includes a second end 412 having a recess 415. Recess 415 includes a first, inclined contact section 416 adjacent to an end face 418 of second end 412 and a second contact section 417 extending toward first end 411 from a lower end of first contact section 416. Second end 412 has a diameter smaller than that of first end 411, and a shoulder 414 is formed between first and second ends 411 and 412.

Sleeve 42 is slidably mounted around rod 41 and includes a first end 421, a second end 422 adapted to couple with a bit 3, and an axial bore 423 extending from first end 421 through second end 422. Several grooves 428 are provided on an outer periphery of first end 421 of sleeve 42 for secure holding by a user. Axial bore 423 includes an enlarged section 424 formed in first end 421 and having an end face 427. A radial bore 425 in communication with axial bore 423 is provided in second end 422 and generally aligns with recess 415 of second end 412 of rod 41. In this illustrated embodiment, second end 422 of sleeve has rectangular cross sections, and a radial flange 426 is formed between first and second ends 421 and 422 of sleeve 42.

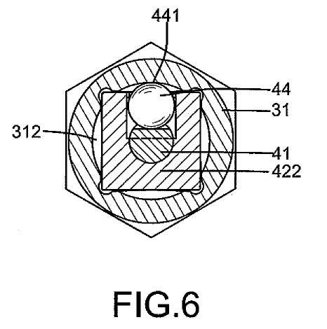

Bit 3 includes a driving end 32 for driving a screw or the like and a socket portion 31 having a rectangular coupling hole 311 (FIG. 6). Coupling hole 311 of bit 3 can engage second end 422 of sleeve 42. A recessed portion 312 is formed in each of four side walls defining coupling hole 311.

Ball 44 is movably received in radial bore 425 of sleeve 42 along a vertical axis of the rod 41. A ring 45 is mounted in an outer end of radial bore 425 and has a diameter less than that of ball 44 so that only part of ball 44 can project out of radial bore 425 of sleeve 42. Ball 44 is also received in recess 415 of rod 41 to engage sleeve 42 with rod 41 and movable between first contact section 416 and second contact section 417 along a longitudinal axis of the rod 41.

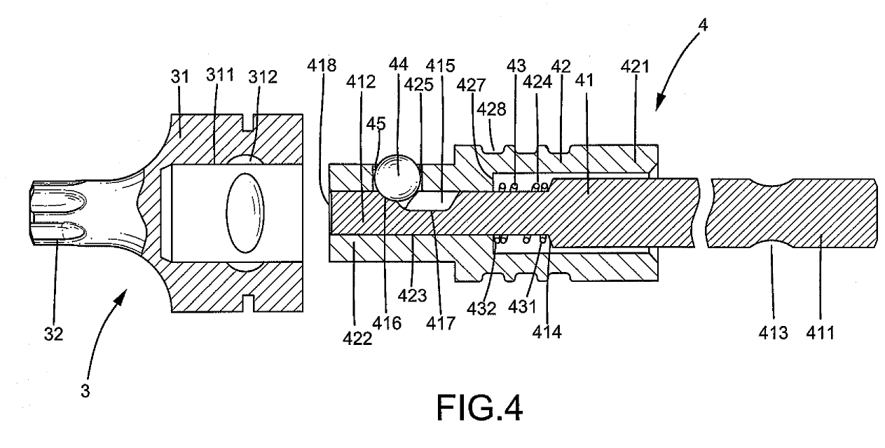

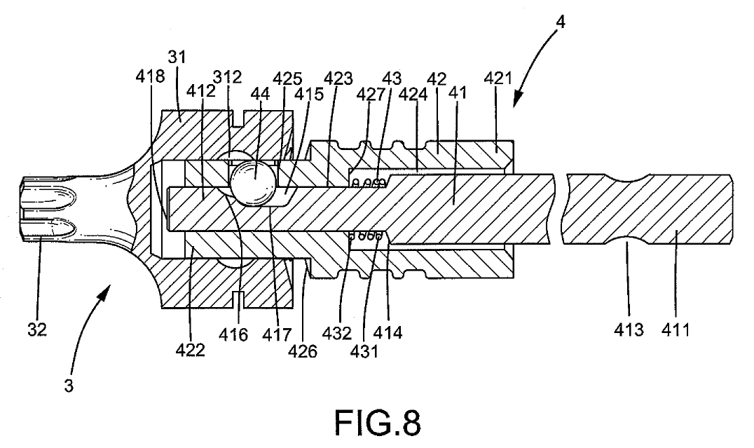

Spring 43 is received in enlarged section 424 of axial bore 423 of sleeve 42 for biasing sleeve 42 towards second end 412 of rod 41. Spring 43 has a first end 431 abutting against shoulder 414 of rod 41 and a second end 432 abutting against end face 427 of enlarged section 424. Sleeve 42 is moveable relative to rod 41 along the longitudinal axis of the rod 41 between an extended first position biased by spring 43 (FIG. 4) and a retracted, second position compressing spring 43 (FIG. 8).

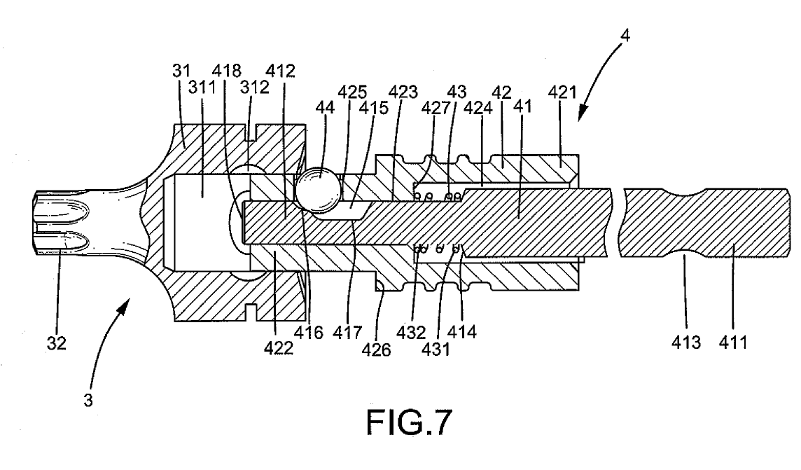

Referring to FIG. 4, when sleeve 42 is moved to the extended, first position, ball 44 is pushed by sleeve 42 and engages in first contact section 416 of recess 415. A depth from first contact section 416 to an outer periphery of rod 41 is shorter than that from second contact section 417 to the outer periphery of rod 41. Namely, first contact section 416 has a depth smaller than second contact section 417. When ball 44 is seated in first contact section 416, an outermost portion 441 of ball 44 projects out of radial bore 425 of sleeve 42 and engages one of recessed portions 312 of bit 3. Referring to FIG. 7, when sleeve 42 is moved to the retracted, second position, ball 44 engages second contact section 417 of recess 415 and does not project out of radial bore 425 of sleeve 42.

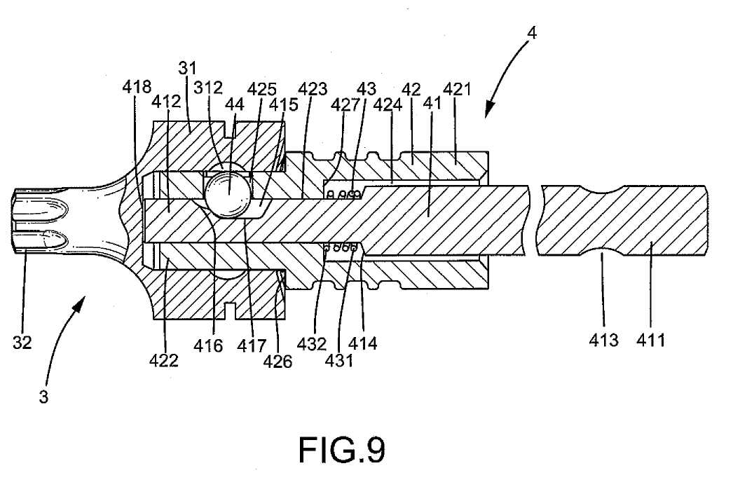

Coupling of bit 3 with quick-release coupler 4 will now be described. When bit 3 is initially engaged with second end 42 of quick-release coupler 4, one of the side walls of coupling hole 311 presses ball 44 and pushes sleeve 42 to move inwardly relative to rod 41 and compress spring 43 (FIG. 7). Then, sleeve 42 is moved to the retracted, second position (FIG. 8) to further compress spring 43, and ball 44 is released to drop from first contact section 416 into second contact section 417 of recess 415. Then, bit 3 is further moved towards sleeve 42 to contact radial flange 426 of sleeve 42, and ball 44 aligns with one of recessed portions 312 of bit 3 (FIG. 9). Then, when bit 3 is released, sleeve 42 and bit 3 are biased by spring 43, and sleeve 42 is moved to the extended, first position in which ball 44 is retained in place by engagement with first contact section 416 of recess 415 and recessed portion 312 of bit 3 (FIG. 2). Thus, bit 3 is securely locked on quick-release coupler 4 as shown in FIGS. 2 and 6 and can be driven when rod 41 of quick-release coupler 4 secured to pneumatic tool 5 rotates.

Coupling hole 311 of bit 3 is of a width such that one of recessed portions 312 of bit 3 is capable of aligning with the second contact section 417 of recess 415 when bit 3 is engaged with second end 422 of sleeve 42, and sleeve 42 moves to the retracted, second position. To remove bit 3 from quick-release coupler 4, the user needs only to grasp the bit 3 (FIG. 2) and push the bit 3 to make sleeve 42 move to the retracted, second position (FIG. 9) such that ball 44 no longer engages recessed portions 312 of bit 3, allowing bit 3 to be removed from sleeve 42 (FIG. 4) when the user firmly grips sleeve 42 and moves bit 3 away from sleeve 42.

The present invention has been described via the detailed illustration of the embodiments. Those skilled in the art can derive variations from the embodiments without departing from the scope of the present invention. Therefore, the embodiments shall not limit the scope of the present invention defined in the claims

1. A quick-release coupler (4) comprising:
a rod (41) including a first end (411) adapted to secure with a pneumatic tool (5) and a second end (412) having a recess (415), with the recess (415) including a first, inclined contact section (416) and a second contact section (417) extending toward the first end (411) from a lower end of the first contact section (416), with a depth from the first contact section (416) to an outer periphery of the rod (41) being smaller than that from the second contact section (417) to the outer periphery of the rod (41);
a sleeve (42) mounted around the rod (41) and including a first end (421) and a second end (422) adapted to couple with a bit (3), with the sleeve (420) further including an axial bore (423) extending from the first end (421) through the second end (422) thereof, with the rod (41) axially extending through the axial (423), with the second end (422) of the sleeve (42) including a radial bore (425) in communication with the axial bore (423), with the radial bore (425) aligning with the recess (415) of the second end (412) of the rod (41);
a ball (44) movably received in the radial bore (425) of sleeve (42) along a vertical axis of the rod (41) and moveably received in the recess (415) of the rod (41) along a longitudinal axis of the rod (41), with the ball engaging the sleeve (42) with the rod (41); and
a spring (43) mounted in the axial bore (423) of the sleeve (42) and biasing the sleeve (42) towards the second end (412) of the rod (41),
with the sleeve (42) being moveable relative to the rod (41) along the longitudinal axis of the rod (41) between an extended, first position biased by the spring (43) and a retracted, second position compressing the spring (43), with the ball (44) being engaged in the first contact section (416) of the recess (415) and an outermost portion (441) of the ball (44) projecting out of the radial bore (425) of the sleeve (42) when the sleeve (42) is in the extended, first position, with the ball (44) being engaged in the second contact section (417) of the recess (415) and not projecting out of the radial bore (425) of the sleeve (42) when the sleeve (42) is in the retracted, second position.

2. The quick-release coupler according to claim 1, with the axial bore (423) including an enlarged section (424) formed in the first end (421) and having an end face (427), with the rod (41) further including a shoulder (414) between the first end (411) and the second end (412), with the spring (43) being received in the enlarged section (424) of the sleeve (42) and including a first end (431) abutting against the shoulder (414) of the rod (41) and a second end (432) abutting against the end face (427) of the enlarged section (424).

3. The quick-release coupler according to claim 1, with the bit (3) including a driving end (32) and a socket portion (31) having a coupling hole (311), with the coupling hole (311) of the bit (3) being engaged with the second end (422) of the sleeve (42), with a recessed portion (312) being formed in each of four side walls defining the coupling hole (311), with the outermost portion (441) of the ball (44) projecting out of the radial bore (425) of the sleeve (42) and engaging one of the recessed portions (312) of the bit (3) when the sleeve (42) is in the extended, first position.
